(19) United States
(12) Patent Application Publication
(10) Pub. No.: US 2016/0004761 A1
(43) Pub. Date: Jan. 7, 2016

(54) PERSON-BASED DISPLAY OF POSTS IN SOCIAL NETWORK

(71) Applicants: Xincheng Zhang, Sunnyvale, CA (US); Jia Liu, Sunnyvale, CA (US)

(72) Inventors: Xincheng Zhang, Sunnyvale, CA (US); Jia Liu, Sunnyvale, CA (US)

(21) Appl. No.: 13/489,306

(22) Filed: Jun. 5, 2012

(51) Int. Cl. G06F 3/048; H04L 12/58; H04L 29/06

(52) U.S. Cl. CPC G06F 17/30598; H04L 65/403; H04L 51/32

(57) ABSTRACT

Methods, systems, and computer programs are presented for providing a Graphical User Interface in a social network. One method includes an operation for generating post groups for a plurality of user posts. The user posts are to be presented to a user of the social network, and each post group includes user posts created by social contacts in the social network. Additionally, the post groups are sorted according to the post time of the most recent user post within the post group. The method further includes an operation for defining, for each post group, the number of user posts to be displayed for each post group. The post groups are displayed in the order determined by the sorting, where the defined number of user posts is displayed for each post group.

### BACKGROUND

The communication capability provided by social networks has opened new forms of communication in today's society, making easier for people to communicate with each other, as well as providing new vehicles of communications between people and businesses, or with community groups. As the use of social networks grows, the amount of messages exchanged in social networks keeps growing. As a result, users of the social networks are having a difficult time screening the messages received to find the interesting messages, which sometimes get lost within the “noise” produce by an abundance of less important messages.

For example, in some social networks, the new posts (e.g., updates from friends in the social network) are shown in chronological order based on the post creation time. This causes two problems. First, some people write many posts, which may take over most, if not all, the real state on the display, causing the user to miss interesting posts from other friends. Second, sometimes a user is interested in quickly finding the post from one friend, but the user must manually scan through all the received posts to find the post from the desired friend.

It is in this context that embodiments arise.

### SUMMARY

Embodiments of the disclosure provide methods, systems, and computer programs for providing a Graphical User Interface in a social network. It should be appreciated that the present embodiments can be implemented in numerous ways, such as a process, an apparatus, a system, a device, or a method on a computer readable medium. Several embodiments are described below.

In some implementations, a method includes an operation for generating post groups from a plurality of user posts. The user posts are to be presented to a first user, and each post group includes user posts created by one user of a social network. Further, the post groups are sorted according to the post time of a user post within the post group. In some implementations, the sorting is based on the most recent user post within the post group. The method further includes an operation for defining, for each post group, the number of user posts to be displayed for the post group. The post groups are displayed in the order determined by the sorting, where the defined number of user posts is displayed for each post group.

These and other embodiments can include one or more of the following features:

Generating the user posts groups further includes determining user posts that were posted within a period of time; determining which users posted the user posts within the period; and generating a post group for each user that posted within the period.

The sorting operation further includes placing first the post group having a most recent user post from the plurality of user posts.

The number for each user group is less than or equal to a maximum number of posts.

The maximum number of posts is configurable by the first user.

The number for each user group is calculated to limit an amount of space utilized to display each post group to a predetermined amount of space.

Providing an option to the first user to display user posts according to a post time of the user posts or to display user posts utilizing the post groups.

Receiving a request from the first user to expand a first post group; and increasing the number of user posts displayed for the first post group in response to the request.

Receiving a request to hide a second post group; and omitting the second post group from the display of the user posts groups in response to the request.

In another embodiment, a computer program embedded in a non-transitory computer-readable storage medium, when executed by one or more processors, for a Graphical User Interface (GUI), includes program instructions for generating post groups from a plurality of user posts to be presented to a first user, where each post group includes user posts created by one user of a social network. The computer program further includes program instructions for sorting the post groups according to a post time of a recent user post within the post group, and program instructions for defining, for each post group, a number of user posts to be displayed in the post group. Further, the computer program includes program instructions for displaying the post groups in an order determined by the sorting, where the defined number of user posts is displayed for each post group.

These and other embodiments can include one or more of the following features:

Generating the user posts groups further includes: program instructions for determining user posts that were posted within a period of time; program instructions for determining which users posted the user posts within the period; and program instructions for generating a post group for each user that posted within the period.

The number for each user group is less than or equal to a maximum number of posts.

In yet another embodiment, a computer implemented method for a graphical user interface (GUI) includes an operation for determining a first group of users from a plurality of users for presenting user posts of the first group of users in a compact state, and an operation for generating post groups for the first group of users. Each post group includes user posts created by one user of a social network. The post groups and user posts from individual users outside the first group of users are sorted, the sorting being based on a post time of a recent user post within the post groups or a post time of the user posts of the individual users. In addition, the method includes an operation for displaying, to a first user, the post groups in the compact state and the user posts from the individual users in an order determined by the sorting. Operations of the method are executed through a processor.

These and other embodiments can include one or more of the following features:

Determining the first group further includes utilizing options configured by the first user for selecting how user posts from each user in the social network are to be displayed.

The options are selected from a group consisting of a star category, compact, hide, or priority.

The user posts from users with a high priority are displayed with a different format than user posts from other users.

Determining the first group further includes including in the first group of users those users having a number of user posts exceeding a threshold.

Determining the first group further includes monitoring interaction between the first user and other users in the social network; and determining the first group of users based on the monitoring.

Determining the first group further includes adding a top number of users according to a corresponding interaction.

Operations of the method are performed by a computer program when executed by one or more processors, the computer program being embedded in a non-transitory computer-readable storage medium.

These embodiments may provide one or more of the following advantages: improve usability, improve user satisfaction, enhance ease of use, improve readability, enable user customization of the presentation of posts in the social network, etc.

Other aspects will become apparent from the following detailed description, taken in conjunction with the accompanying drawings.

### BRIEF DESCRIPTION OF THE DRAWINGS

The implementations may best be understood by reference to the following description taken in conjunction with the accompanying drawings.

FIG. 1 is a person's web page for interfacing with a social network, according to one implementation.

FIG. 2 illustrates a user interface that displays user posts by person, according to some implementations.

FIG. 3 illustrates a user interface with a hybrid display of user posts, according to some implementations.

FIG. 4 illustrates a user interface for configuring the display options, according to some implementations.

FIG. 5 provides one example architecture of a system that may utilize implementations described herein.

FIG. 6 shows an architecture for the implementations described herein.

FIG. 7 shows a flowchart illustrating a process for implementing a Graphical User Interface (GUI), in accordance with one implementation.

FIG. 8 is a schematic diagram of a computer system for the implementations described herein.

### DETAILED DESCRIPTION

The following implementations describe methods, systems, and computer programs are presented for providing a Graphical User Interface in a social network. The GUI enables a user to manage the display of electronic messages from users in the social network, e.g., by prioritizing the messages from particular users, or by using about the same amount of real space on the display for the posts from each user.

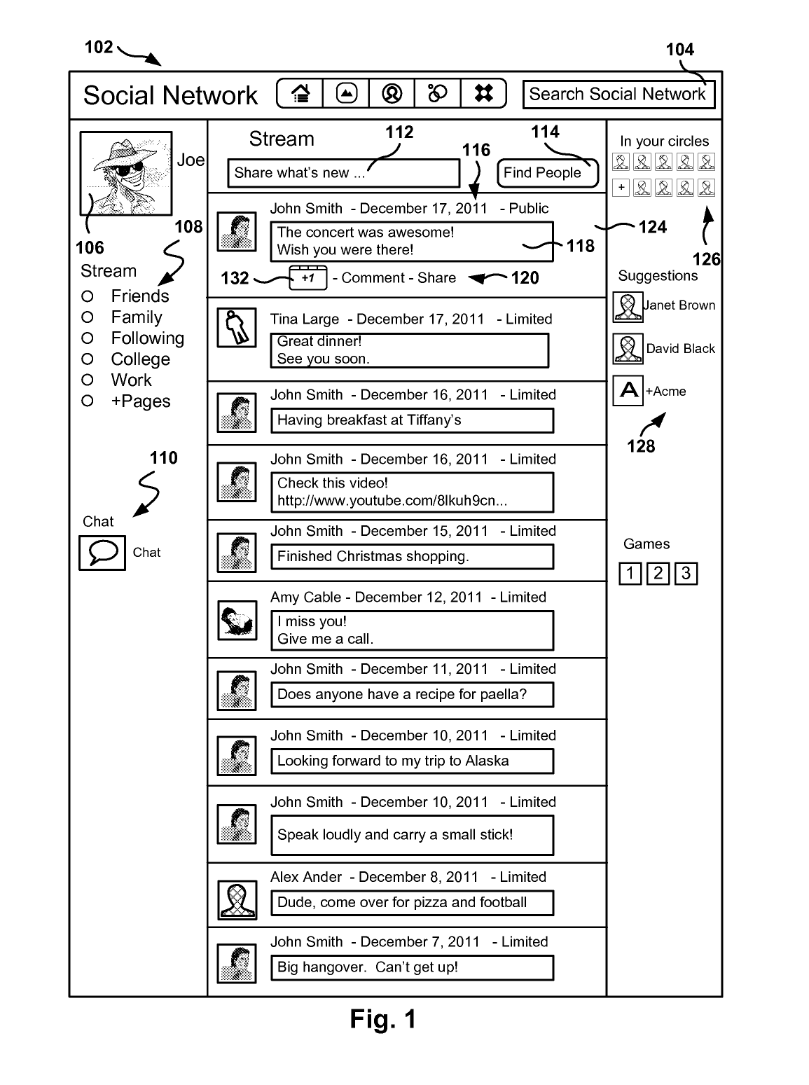

FIG. 1 is a person's web page for interfacing with a social network, according to one implementation. For example, FIG. 1 shows the GUI presented to the person (named Joe Hat) to view messages 124 posted on the social network. In some implementations, the posts (also referred to herein as messages, electronic messages, updates, etc.) received by a user are referred to as the stream of the user in the social network. Page 102 is an example snapshot of a page for viewing a person's stream in the social network. Search field 104 is an input area for searching the social network or other Internet content.

In some implementations, the stream is presented in the middle panel of page 102. Input box 112 enables the person to add new posts in the social network, and input box 114 enables the user to search for friends or entities on the social network. When the person enters a new post, the person is able to select the destination for the post. The destination could be the complete social network (e.g., a public post), a person, or one or more groups defined by the person.

In some implementations, the groups defined by the person are referred to as “circles,” but other configurations for defining groups are also possible. Examples include various graphically designed interfaces or text based lists, dialog boxes, pull downs, radio buttons, and other interfaces defined from a combination of graphical elements, text, images, pictures, combinations thereof, etc. In some implementations, the post may be a text message, a photo, a video, a link to a webpage, or a location of the person. Thus, the content and form of the post should be broadly construed to include any data that can be presented, displayed, listened to, interfaced with, received, sent, shared, approved, or disapproved, etc. In some implementations, the stream includes posts added by the person, by others socially linked to the person, or by an entity that the person has chosen to follow (e.g., be linked with/to in the social network).

In some implementations, each post 124 may include information 116 about the author, the timestamp of the post, and the scope of the post (e.g., public, limited, etc.). Example post 124 may include a text message 118 entered by person “John Smith,” but other types of posts are possible, such as a photo, a video, a link, data, etc. The social network provides options 120 to respond to the post, such as providing an endorsement of the post 132, adding a comment 120 to the post, or sharing the post with others.

As used herein, an endorsement 132 is a public recommendation of an item, such as a webpage, a person, a post, an entity, etc. An endorsement may also be referred to or provided as an acknowledgment, a +1, a thumbs-up, a √ (check) mark, a confirmation, a ratification, a validation, a seal of approval, a testimonial, support, advocacy, an approval, a ratification, etc.

A profile picture of the person 106 may be provided on the left side of page 102. In addition, stream filtering options 108 allows the person to limit or tune what is presented on the stream. In some implementations, the filtering options included radio buttons to select or deselect the groups created by the person. In addition, the filtering options also include a radio button to enable or disable messages from entity pages in the stream. Although radio buttons are used, other types of user selectable controls may be used, such as drop downs, text fields, toggles, voice inputs, etc. In some implementations, a chat button 110 is provided to allow the person to engage in conversation with others in the social network. On the right panel, icons 126 represent users in the social network that are linked with the person. In addition, the social network provides suggested new users in area 128. It is again noted that the layout of the features on the page 102 is only one example, and the layout can vary based on site designer preferences.

In the implementation of FIG. 1, the user John Smith has produced a relatively large amount of posts, as compared to the posts created by other users. As a result, the messages from other users (e.g. Amy Cable or Alex Ander) may get lost inside the large number of messages created by John Smith. Implementations allow people to control how social messages are displayed, and to control the amount of real space used on the display to show messages from each friend on the social network.

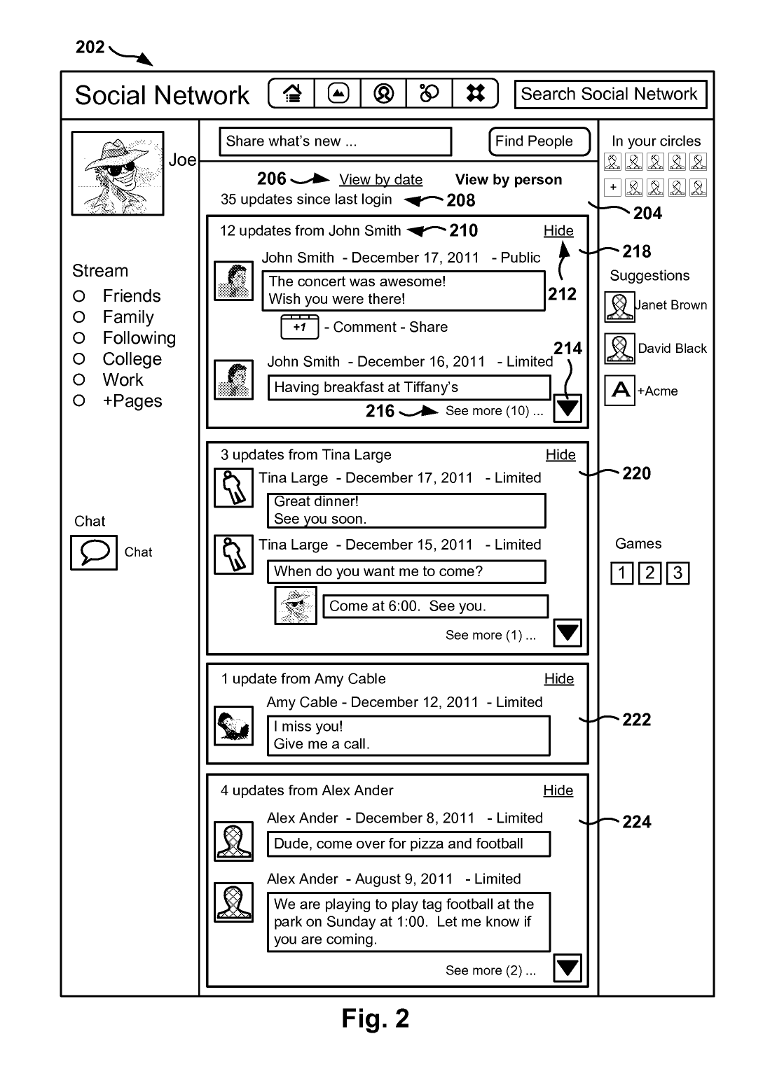

FIG. 2 illustrates a user interface 202 that displays user posts by person, according to some implementations. In some implementations, the messages to be displayed for the user of the social network are grouped according to the person that created the post. Webpage 202 provides an option 206 to view messages “by date” or “by person” in the middle panel 204. The “view by date” option causes the messages of the social network to be posted according to their creation time, with the newest message displayed first. In some implementations, a reverse order is also possible, which causes the oldest message to be posted first, and the newest message to be posted last. The “view by date” option does not group messages according to the creator of each message.

The “view by person” option, which is the option selected to display webpage 202, creates groups of electronic messages from the same creator (e.g., John Smith) into a single block (e.g., 218). Therefore, each block (e.g., blocks 218, 220, 222 and 224) includes messages originated by only one user. In some implementations, each block may have messages for more than one user. A user may select to include all messages from a group of people in the same block. For example, a block may display all the messages from the same circle of users, or a block may display all the messages from a defined set of users (e.g., players in my football team, messages about my high school reunion, etc.).

In some implementations, the number of new messages 208 (e.g., updates) received after the last time the user logged in is displayed on the page. The posts from one creator are placed into a block 218, also referred to herein as a thread or a group. Within each block, the posts are organized according to their creation time in chronological order, or in some implementations, in reversed chronological order. In webpage 202, the posts within each block are displayed with the newest post first follow by older posts, if any, in chronological order. In some implementations, the block includes a message indicating how many messages (e.g., updates) have been created by the corresponding user since the last login.

In webpage 202, 35 updates have been created since the last login, with John Smith having created 12 updates, Tina Large 3 updates, Amy Cable 1 update, etc. In some implementations, an option is made available to the user to expand the number of messages shown in the block, and message 216 displays how many more updates are available. When the user clicks on the expand button 216, additional post are presented to the user. The user may continue to click on the expand button 216, as long as there are additional posts not yet visible.

In another implementation, a scroll bar is presented on the right side of the block instead of the expand button. As the user moves the pointer on the scroll bar downwards, the block presents older posts from the same author. With the scroll bar, the amount of space utilized by the block does not change as the user views older posts, but on the other hand, the user is limited to a certain amount of space to view posts from another user.

It is noted that although implementations are described with reference to updates, implementations may also be utilized to display older messages, even those messages created before the last login. The implementations illustrated in FIG. 2 should therefore not be interpreted to be exclusive or limiting, but rather illustrative. Therefore, a user may utilize button 214 to display other updates or older messages originated by the corresponding friend. In some implementations, a “hide” option 212 is provided, which when selected causes the messages from the block to be hidden. A short message (e.g., “Show messages from John Smith”) is displayed instead to allow the user to be able to see the messages from this user again, if so desired. In some implementations, the message about the “hidden” user is not displayed on the screen.

In some implementations, the number of posts initially shown in each block is fixed (e.g., 2, 3, 5, etc., although other values are also possible). In webpage 202, two messages are displayed for each person. Of course, if there is only one message from a given person (e.g., block 222) then only one message is displayed. In some implementations, the number of messages to be displayed per block is configurable by the user. By limiting the number of messages shown for each person, a “busy” producer will not overtake the display space, allowing all users to have their messages displayed with the same prominence, independently of how many posts each user creates.

In some implementations, the number of messages displayed per block may vary, but each block is assigned a maximum amount of space on the display. This way, a creator that posts short messages may have more messages visible in the block than a creator that generates longer posts. The defining factor for how many posts to include in the block is the amount of real space allotted to each block. The social network will include as many posts as possible in the block without exceeding the amount of display space available for the block. Users that have low activity levels (e.g. user Amy Cable) may not have enough messages to fill the allotted amount of space for the block. In some implementations, the amount of display space reserved for the low-activity blocks is reduced enough to accommodate the posts available, and in other implementations, the amount of display space reserved for the low-activity blocks is kept to the amount of display space available to all blocks, even if this means having white space in the block. This layout provides a uniform look, with the posts from all users taking the same amount of space in the webpage.

In some implementations, post groups from a plurality of user posts are created. The user posts are for presentation to a first user, where each post group includes user posts created by one user of the social network. The post groups are sorted according to the post time of the most recent post within each of the post groups. The number of user posts to be included in each block is selected, where the number of user posts may be different for each of the blocks in some implementations, or may be the same in some other implementations. Afterwards, the post groups are displayed in the order determined during the sorting operation.

To create the blocks, the method first determines which are the user posts that were created within a given time period. The time period may be defined by the time elapsed since the last login, or by some other metric, e.g., last week, last month, this month, today, etc. The method then determines which users have created user posts within the defined time period, and then the blocks are created for each of the users that have posts within the defined time period.

In some implementations, the blocks are sorted according to time, more specifically, according to the time of the most recent post within each block. As a result, the blocks are displayed in chronological order, where the chronological order is established by the newest post in the block. Consequently, the block with the most recent user post will be displayed first (e.g., on top), then the newest post not in the first block will determine the block that is listed next, etc.

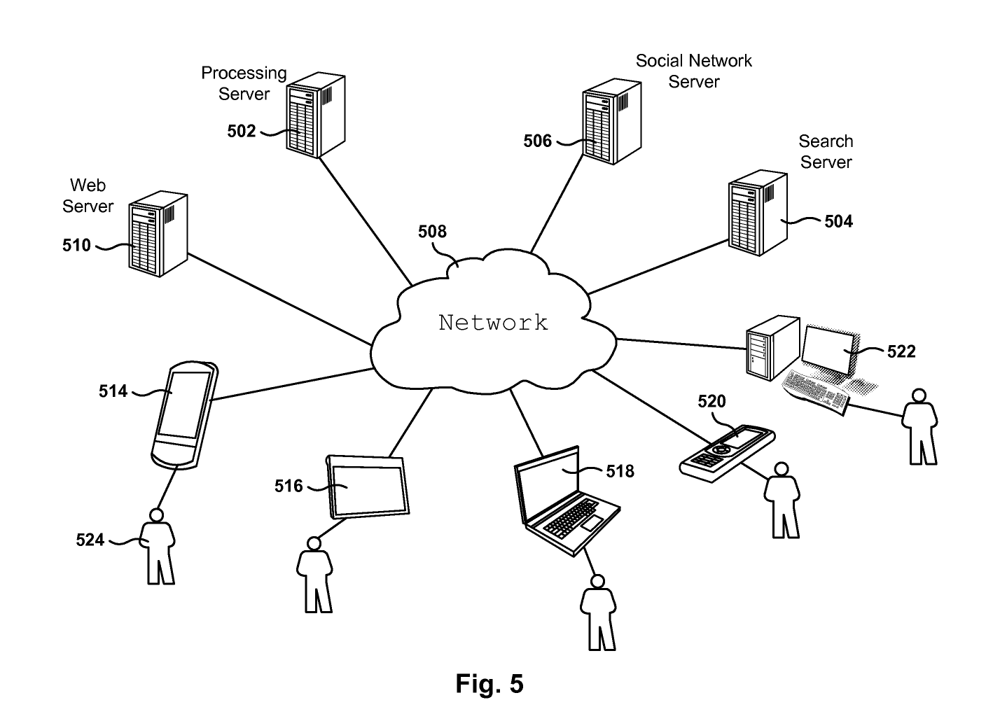

In some implementations, the blocks are sorted according to a calculated likelihood that the reader is interested in reading the block. The social network monitors the activities of the reader, and based on the amount of interactivity between the reader and the reader's social contacts, the social network determines what are the social contacts that have had the most interaction with the user. As a result of the monitoring, the social network calculates a priority for each of the user's contacts, and the blocks are organized according to this priority. In some implementations, the priority is determined by the viewer. See for example, the description below with reference to FIG. 5 describing a user interface for configuring display options.

In some implementations, all the blocks are shown initially in a collapsed state, also referred to herein is a compact state. A short description is included for each block (e.g., “10 updates from John Smith”), and the user may select a block to have the block displayed in an expanded state, which presents one or more post from the selected block.

It is noted that the implementations illustrated in FIG. 2 are illustrative. Other implementations may utilize different blocks, different sorting mechanisms, different amount of space reserved for posts, present the blocks in a different layout on the screen, etc. The implementations illustrated in FIG. 2 should therefore not be interpreted to be exclusive or limiting, but rather illustrative.

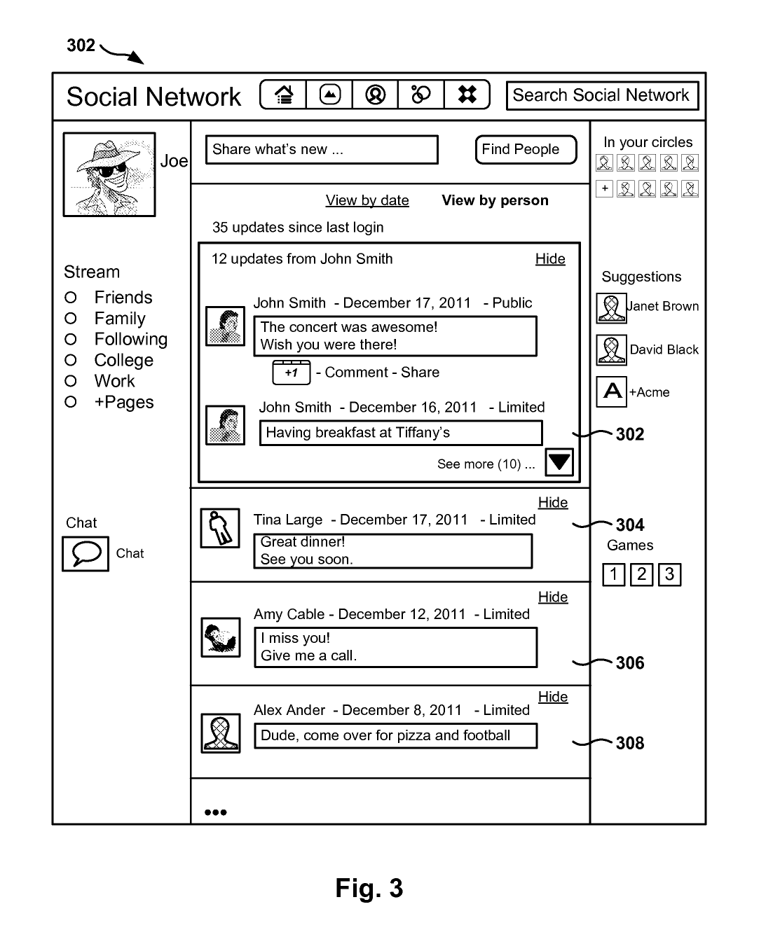

FIG. 3 illustrates a user interface 302 with a hybrid display of user posts, according to some implementations. In some implementations, a hybrid approach is used to display the user posts, where posts from certain users are displayed in a block (e.g., in a compact state), while posts from other users are presented without blocks, e.g., posts are presented in the same format as in the “view by date” mode.

In some implementations, the posts are listed according to their creation time, but if there is a user that has too many posts (e.g., the number of posts exceeds a predetermined threshold of maximum number of posts to display without compression), the posts from this user are put in a block, while the rest of the posts from other users are still listed individually.

With reference to FIG. 3, the social network has determined that user John Smith has too many posts, e.g., user John Smith exceeds a threshold of posts. In some implementations, the threshold is defined as 2, 3, 5, 10, etc. posts for the single-user, but other values are also possible. Since user John Smith has exceeded the threshold, the posts from this user are placed in a block 302. The rest of the users do not exceed the threshold, therefore, the posts for the rest are listed individually (e.g., posts 304, 306, and 308).

In some implementations, a computer implemented method includes an operation for determining a first group of friends, from a plurality of friends that have messages for the viewer. The posts for the first group are to be presented the compact state, while the posts for other friends are to be listed individually. In some implementations, the first group includes those users that have a number of posts exceeding a predetermined threshold. In other implementations, the social network monitors the interaction between the viewer and other users to determine which users belong to the first group, as discussed above. In some implementations, the first group is determined by selecting a certain amount of users that produce the most posts, e.g., the first group includes the top 3 producers of posts.

Blocks of posts are created for the first group of users, and then the blocks and the individual posts are sorted according to the creation time (e.g., post time) of the most recent post within a block or the post time for the individual posts. The blocks and the individual user posts are then displayed after performing the sort operation.

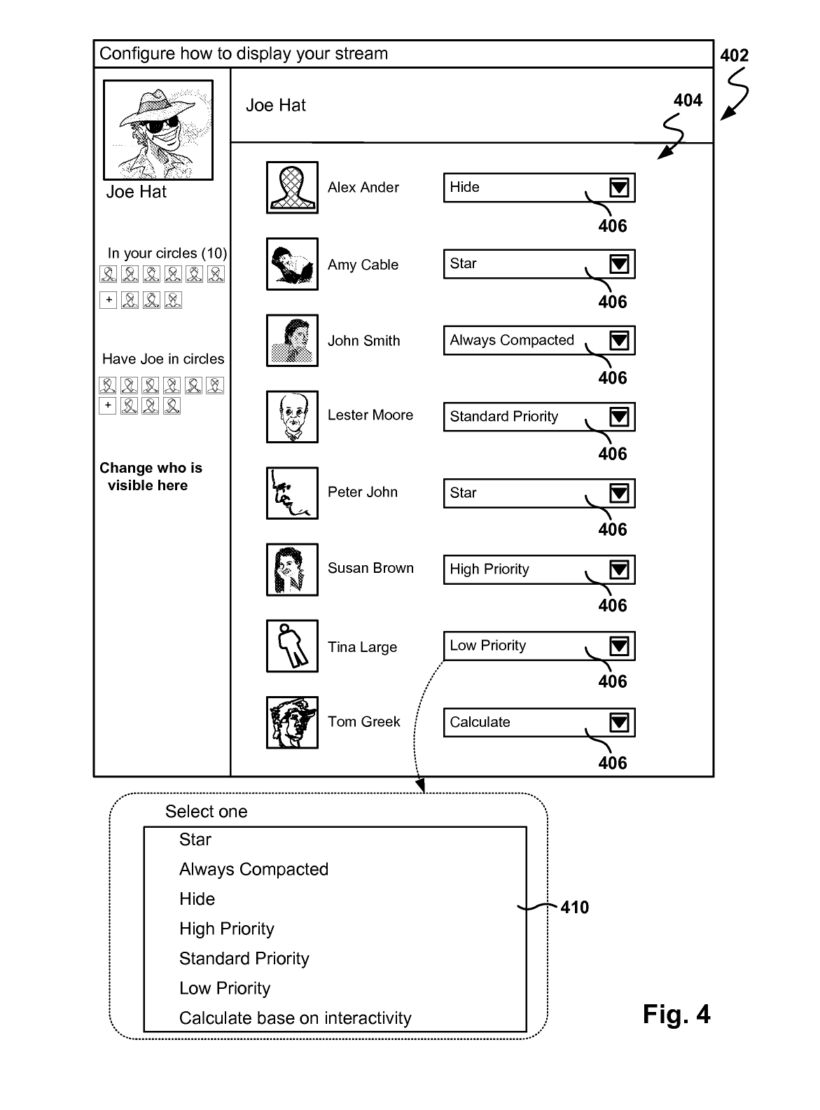

In some implementations, the social network identifies posts that have a higher priority than regular posts. For example, posts from certain users identified by the reader are given a higher priority (see below the description with reference to FIG. 4), or the posts from users with a high interactivity level with the reader. In some implementations, the posts with a higher priority are presented in a different format than other posts. For example, the higher priority posts may include a bigger font, a different font, a different font attribute (e.g., bold, underscored, or italics), a different icon, a different color, etc.

FIG. 4 illustrates a user interface for configuring the display options, according to some implementations. In some implementations, the reader may prioritize the way posts from friends are displayed by selecting a different priority or a different display function for each user of the social network. In some implementations, the posts from users with the highest priority are displayed first.

Webpage 402 illustrates a user interface for configuring the way posts from users are displayed in the user's page of a social network. A webpage 402 includes a configuration area 404 that lists the reader's friends and a selection box 406 for choosing the display method to be utilized for each social contact.

In some implementations, a star rating may be assigned to a user and those users with the star rating will have their posts displayed before the posts from users without a star rating. In some implementations, an option is available to display only posts from users with a star rating.

In some implementations, an option is available to let the social network decide how to display messages from a particular user, or from all users. The social network determines a level of importance for each friend, and the level of importance may be utilized to determine how the posts are displayed for each users. For example, the post from users that have a high level of interactivity with the reader are posted at the top of the page, or with some other distinctive format, or with a different font, etc. In some implementations, the level of interactivity (e.g., importance) is based on the number of times that the viewer has posted a message for another user.

FIG. 4 illustrates an implementation that enables the viewer to set a display option for each of the users. A pull-down menu 406 is provided next to each user in order to configure how the user is displayed on the viewer's stream. If the viewer clicks on the pull-down menu 406, a list of options 410 are provided for selection by the viewer. In some implementations, the options include a star, show posts always in the compacted form, hide, high priority, standard priority, low priority, calculate based on interactivity, etc.

It is noted that the implementations illustrated in FIG. 4 are for illustration purposes. Other implementations may utilize different webpage layouts, include a different option-selection mechanism, provide selection mechanisms for more than one user at the same time, include a subset of the options described above, include other display options besides those shown above, etc. The implementations illustrated in FIG. 4 should therefore not be interpreted to be exclusive or limiting, but rather illustrative.

FIG. 5 provides one example architecture of a system that may utilize implementations described herein. Users 524 interact with each other in the context of a social network, where users include people and entities. Each user has an account in the social network, and the account includes at least a user name. In addition, each account includes a profile of the user with additional information about the user, e.g., residence, favorite activities, etc. The user is in control of what information is added to the profile, and what information is shared with others. A user may access the social network through different devices e.g., a smart phone 514, a tablet computer 516, a laptop 518, a mobile phone 520, a personal computer 522, or any computing device that provides access to the Internet. Of course, the illustrated devices are only examples.

In some implementations, social network server 506 delivers services that enable users to interface with each other. The social network provides a site that enables users to define user accounts, which can be accounts for people and entity accounts. Through those accounts, users are able to connect with their friends, group of friends, entities, groups of entities, etc. In some implementations, the relationships established in the social network may be utilized in other contexts and websites. Search server 504 provides Internet search capabilities.

Processing server 502 manages the display of posts on the user stream as well as the configuration of display options, and associated user interfaces. Processing server 502 interfaces with web server 510, social network server 506, search server 504, and client devices to perform post-display operations.

In some implementations, the social network provides entities with a specific type of interface for posting messages, communicating, sharing, and generally interacting within the social network. In some implementations, this interface for entities is referred to as “plus pages,” indicated by a token, e.g., “+”, followed by the name of the entity in the social network (e.g., Acme corporation has a “+Acme” page). Real-persons have “person pages,” which are different from plus pages and have different functionality, although some features are common to both plus pages and person pages. Although the symbol “+” and word “plus” is referred to herein as denoting a type of site or place within the social network, it should be appreciated that any symbol, identifier, word, or character may be used to define or identify the social services. In an alternate implementation, the services can be provided without the use of any special symbols or denoted nomenclature. Thus, so long as the social network site provides the functionality defined herein, the nomenclature utilized to denote the services can take on any form, format or identifier.

Other implementations may utilize different servers, have the functionality of one server distributed over a plurality of servers, have the functionality of two or more servers combined into a single server, have a different amount of display categories in the social network, prioritize user posts with different criteria, provide different options for displaying posts, etc. The implementations illustrated in FIG. 5 should therefore not be interpreted to be exclusive or limiting, but rather illustrative.

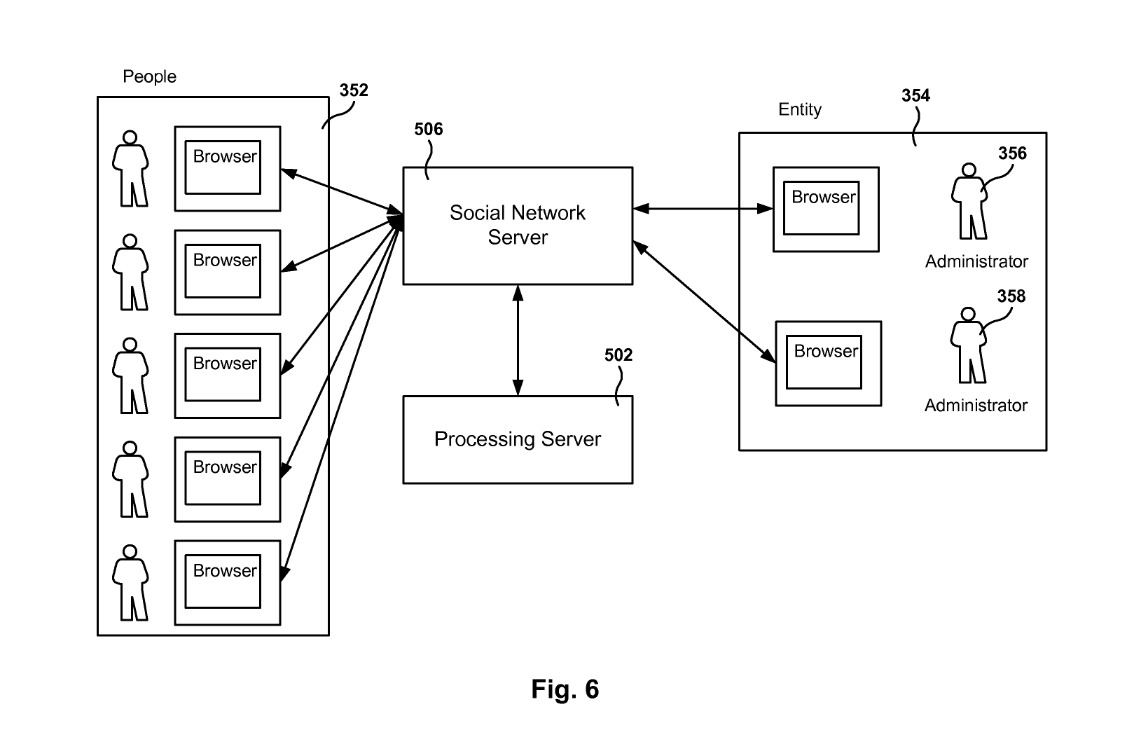

FIG. 6 shows an architecture for the implementations described herein. People 352 access the social network 506 utilizing a web browser, or some other similar application (e.g., app in smart phone). Entity 354 includes one or more administrators 356, 358 that access the social network via a network browser or some other similar application or interface provided by the social network.

Processing server 502 manages the implementation of post-display functionality, and exchanges electronic messages with other servers and client devices. When a user performs an action affecting the display of posts, the browser of the user interfaces with the processing server, or with another server that interfaces with the processing server, to perform the display-related action.

It is appreciated that the implementations illustrated in FIG. 6 may utilize different rules, different servers, combine the functionality of different servers into one server, distribute the functionality of one server among several servers, etc. The implementations illustrated in FIG. 6 should therefore not be interpreted to be exclusive or limiting.

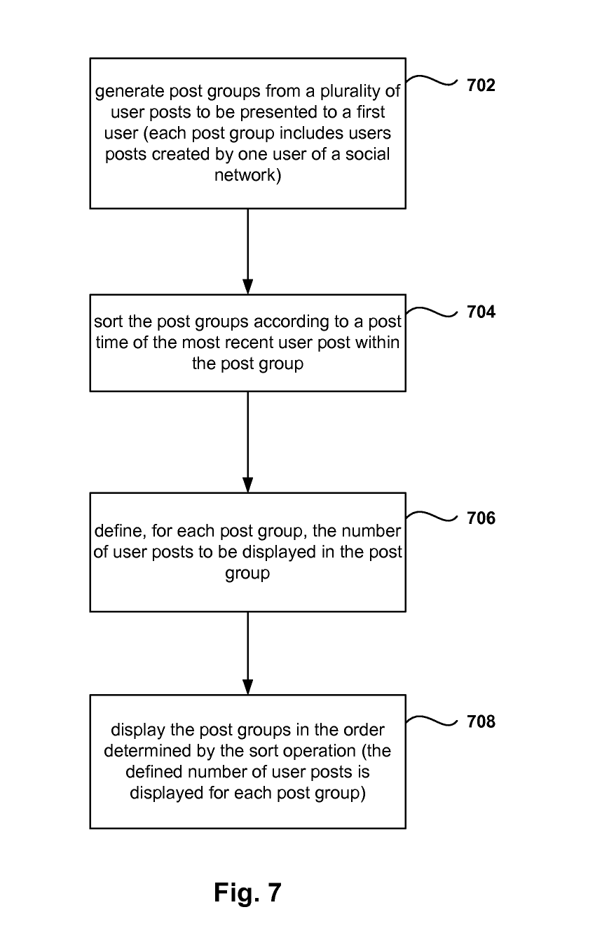

FIG. 7 shows a flowchart illustrating a process for implementing a Graphical User Interface (GUI), in accordance with one implementation. In operation 702, post groups are generated for the plurality of user posts to be presented to the viewer (e.g., first user). In some implementations, each post group (e.g., block) includes the posts created by one user in the social network. See for example blocks 218 and 220 in FIG. 2.

From operation 702, the method proceeds to operation 704 where the post groups are sorted according to the post time of a recent post within the post group (e.g., within the block). Further, after operation 704, the method flows to operation 706 where the number of user posts to be displayed for each of the blocks is defined. In some implementations, the number of user posts is the same for all the blocks to be displayed, and in other implementations the number of user post is different for some of the blocks.

Further yet, from operation 706 the method flows to operation 708, where the post groups are displayed in the order previously determined during the sort operation. For each of the blocks, the number of posts defined in operation 706 is displayed.

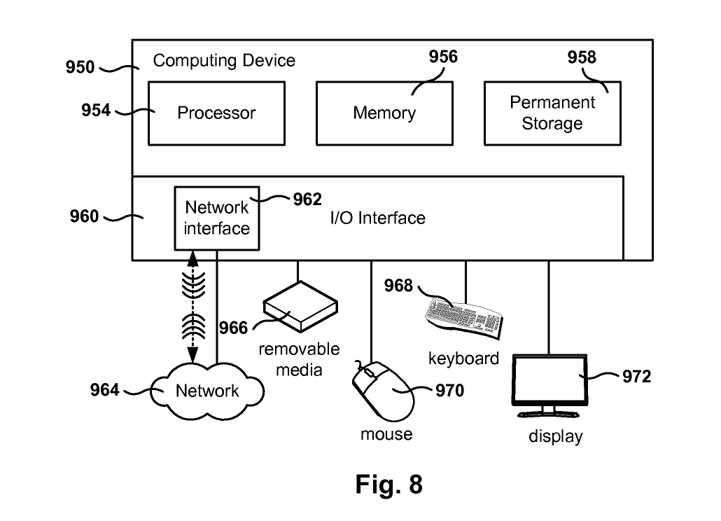

FIG. 8 is a schematic diagram of a computer system for the implementations described herein. It should be appreciated that the methods described herein may be performed with a digital processing system, e.g., a conventional, general-purpose computer system. Special purpose computers, which are designed or programmed to perform only one function, may be used in the alternative. The computing device 950 includes a processor 954, which is coupled through a bus to memory 956, permanent storage 958, and Input/Output (I/O) interface 960.

Permanent storage 958 represents a persistent data storage device e.g., a hard drive or a USB drive, which may be local or remote. Network interface 962 provides connections via network 964, allowing the exchange of electronic messages (wired or wireless) with other devices. It should be appreciated that processor 954 may be embodied in a general-purpose processor, a special purpose processor, or a specially programmed logic device. Input/Output (I/O) interface 960 provides communication with different peripherals and is connected with processor 954, memory 956, and permanent storage 958, through the bus. Sample peripherals include display 972, keyboard 968, mouse 970, removable media device 966, etc.

Display 972 is configured to display the user interfaces described herein. Keyboard 968, mouse 970, removable media device 966, and other peripherals are coupled to I/O interface 960 in order to exchange information with processor 954. It should be appreciated that data to and from external devices may be communicated through I/O interface 960. Implementations can also be practiced in distributed computing environments where tasks are performed by remote processing devices that are linked through a wired or a wireless network.

Implementations can be fabricated as computer readable code on a non-transitory computer readable storage medium. The non-transitory computer readable storage medium holds data which can be read by a computer system. Examples of the non-transitory computer readable storage medium include permanent storage 958, network attached storage (NAS), read-only memory or random-access memory in memory module 956, Compact Discs (CD), Blu-ray™ discs, flash drives, hard drives, magnetic tapes, and other data storage devices. The non-transitory computer readable storage medium may be distributed over a network-coupled computer system so that the computer readable code is stored and executed in a distributed fashion.

Some, or all operations of the method presented herein are executed through a processor, e.g., processor 954 of FIG. 8. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Implementations presented herein recite a device or apparatus. The apparatus may be specially constructed for the required purpose or may be a general purpose computer. The apparatus includes a processor capable of executing the program instructions of the computer programs presented herein.

Although the foregoing implementations have been described with a certain level of detail for purposes of clarity, it is noted that certain changes and modifications can be practiced within the scope of the appended claims. Accordingly, the provided implementations are to be considered illustrative and not restrictive, not limited by the details presented herein, and may be modified within the scope and equivalents of the appended claims.

What is claimed is:

1. A method comprising:
generating post groups from a plurality of user posts, each post group comprising one or more of the plurality of user posts from a defined set of users to be presented to a first user;
sorting, by a processor, the post groups according to a post time of a user post within the post group and an amount of interactivity between the first user and at least one of the users from the defined set of users;
for each post group, defining a number of user posts to be displayed for the post group; and
displaying the post groups in an order determined by the sorting, wherein the defined number of user posts is displayed for each post group.

2. The method of claim 1, wherein each post group comprises user posts created by one user of a social network.

3. The method of claim 1, wherein sorting the post groups is performed based on a most recent user post within each post group.

4. The method of claim 1, wherein generating the post groups further comprises:
determining user posts that were posted within a period of time;
determining which users posted the user posts within the period; and
generating a post group for each user that posted within the period.

5. The method of claim 1, wherein the sorting further comprises:
placing first the post group having a most recent user post from the plurality of user posts.

6. The method of claim 1, wherein the number for each user group is less than or equal to a maximum number of posts.

7. The method of claim 6, wherein the maximum number of posts is configurable by the first user.

8. The method of claim 1, wherein the number for each post group is calculated to limit an amount of space utilized to display the each post group to a predetermined amount of space.

9. The method of claim 1, further comprising:
providing an option to display user posts according to a post time of the user posts or to display user posts utilizing the post groups.

10. The method of claim 1, further comprising:
receiving a request to expand a first post group; and
increasing the number of user posts displayed for the first post group in response to the request.

11. The method of claim 1, further comprising:
receiving a request to hide a second post group; and
omitting the second post group from the display of the user posts groups in response to the request.

12. A non-transitory computer-readable storage medium having a computer program embedded thereon which, when executed by one or more processors, cause the one or more processors to perform operations comprising:
generating, by the one or more processors, post groups from a plurality of user posts, each post group comprising user posts created by a defined set of users;
sorting the post groups according to a post time of a most recent user post within the post group and an amount of interactivity between a first user and at least one of the users from the defined set of users;
defining, for each post group, a number of user posts to be displayed for the post group; and
displaying, to the first user, the post groups in an order determined by the sorting, wherein the defined number of user posts is displayed for each post group.

13. The computer-readable storage medium of claim 12, wherein generating the post groups further comprises:
determining user posts that were posted within a period of time;
determining which users posted the user posts within the period; and
generating a post group for each user that posted within the period.

14. The computer-readable storage medium of claim 12, wherein the number for each user group is less than or equal to a maximum number of posts.

15. A method comprising:
generating post groups from a plurality of user posts, each post group comprising user posts created by a defined set of users;
sorting, by a processor, the post groups and user posts from individual users outside the defined set of users based on an amount of interactivity between a first user and the defined set of users or the individual users outside the defined set of users and a post time of a most recent user post within the post groups or a post time of the user posts of the individual users; and
displaying to the first user the post groups in the compact state and the user posts from the individual users in an order determined by the sorting.

16. The method of claim 15, further comprising:
utilizing options configured by the first user for selecting how user posts from each user are to be displayed.

17. The method of claim 16, wherein the options comprise at least one of a star category, compact, hide, or priority.

18. The method of claim 17, wherein user posts from users with a high priority are displayed with a different format than user posts from other users.

19. The method of claim 15, further comprising:
including in the defined set of users those users having a number of user posts exceeding a threshold.

20. The method of claim 15, further comprising:
monitoring interaction between the first user and other users in a social network; and
determining the defined set of users based on the monitoring.

21. The method of claim 20, further comprising adding a top number of users to the defined set of users according to a corresponding interaction.

22. (canceled)
